(19) United States
(12) Patent Application Publication
(10) Pub. No.: US 2012/0198101 A1
(43) Pub. Date: Aug. 2, 2012

(54) MOBILE DEVICE PERIPHERAL DETECTION WITH INDEPENDENT STATE MACHINES

(76) Inventors: Brewster Porcella, Biddeford, ME (US); Randall Wetzel, Scarborough, ME (US)

(21) Appl. No.: 13/359,733

(22) Filed: Jan. 27, 2012

Related U.S. Application Data
(60) Provisional application No. 61/436,845, filed on Jan. 27, 2011.

(51) Int. Cl. G06F 3/00

(52) U.S. Cl. 710/12; 710/15

(57) ABSTRACT

This document discusses, among other things, methods and apparatus for detecting an attached state of a port of a device. In an example, a method can include monitoring a supply bus pin of a USB port for a valid voltage using a first state machine, monitoring an ID pin of the USB port for a non-floating voltage using a second state machine, and simultaneously and independently executing the first state machine and the second state machine, wherein the first state machine is different than the second state machine.

### CLAIM OF PRIORITY

This patent application claims the benefit of priority, under 35 U.S.C. Section 119(e), to Porcella et al., U.S. Provisional Patent Application Ser. No. 61/436,845, entitled “CELL PHONE PERIPHERAL DETECTION WITH INDEPENDENT STATE MACHINES,” filed on Jan. 27, 2011, (Attorney Docket No. 2921.108PRV), which is hereby incorporated by reference herein in its entirety.

### BACKGROUND

Electronic devices, from integrated circuits to portable electronic devices and beyond, have evolved in some markets to become smaller and yet more powerful than their predecessor devices. Increased processing power has enabled the devices to include more and varied functionality. Yet, the smaller size has created physical connectivity challenges.

Some connectivity challenges have been addressed by allowing multiply and diverse accessory devices to use a common connection port. For convenience, device programmers have implemented strategies to automatically detect functions supported by an accessory device shortly after the accessory is couple to the electronic device. In addition, standard connection and communication protocols, for example Universal Serial Bus (USB) protocols, have provided specifications for identifying accessory devices that conform to a respective protocol. As development has evolved, nonconforming accessories have been developed that take advantage of a standard physical connection but can be identified using strategies not covered by the protocol standard. To accommodate such non-standard accessories making use of a standard connection, accessory identification strategies have been developed that combine into a single algorithm both the standard identification specification and non-standard identification techniques. For example, some parts, such as micro USB parts, incorporate such identification, or discovery, algorithms in hardware. Attempts to modify data flow in such parts, for different peripherals, can become unwieldy.

### Overview

This document discusses, among other things, methods and apparatus for detecting an attached state of a port of a device. In an example, a method can include monitoring a supply bus pin of a USB port for a valid voltage using a first state machine, monitoring an ID pin of the USB port for a non-floating voltage using a second state machine, and simultaneously and independently executing the first state machine and the second state machine, wherein the first state machine is different than the second state machine.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a flowchart for an example method that simultaneously executes two independent state machine methods to discover when a peripheral device is attached to or detached from a port.

FIG. 2 illustrates generally a flowchart of an example Universal Serial Bus (USB) discovery method.

FIG. 3 illustrates generally a flowchart of an example of an identification (ID) resistance discovery method.

FIG. 4 is a block diagram of a machine, such as a mobile device, in the example form of a computer system.

### DETAILED DESCRIPTION

The inventors have recognized that as more and more accessory devices become available, some of which having very diverse functionality, the single algorithm approach to accessory identification has presented a burden on timely and accurate accessory identification. The present subject matter describes various state machines that can be run alone or simultaneously to assist in identifying accessory devices using a common port, for example, of an electronic device, such as a cell phone, a media player, a mobile media player, a personal digital assistants (PDA), pad computers, text displays including electronic book readers, etc. In certain examples, a single identification algorithm can be separated into multiple state machines to allow more flexibility in identifying accessory devices. In an example, a USB identification state machine can be divorced from an identification (ID) resistance state machine. The separate state machines can provide a programmer with flexibility in dealing with multiple potential functions and expanding functionality as new accessories, or peripherals, are defined and made available. In certain examples, the separate state machines can abstract peripheral identification information to a set of parameters. The parameters can allow a programmer to develop identification algorithms of varying complexity that can sense and identify, using a single physical port, many different peripheral devices compatible with the physical connector associated with the port, including peripheral devices yet to be developed.

Compared to a single algorithm approach to discovering a connected peripheral device, the present subject matter can simplify detected information associated with a connected device and can provide greater flexibility for configuring interface electronics with the device, such as switches associated with the interface electronics. In certain examples, adjusting a discovery method or protocol can be more efficient with the multiple algorithms because the functions of each algorithm are not intertwined as in a single algorithm method and a change with discovering a new ID resistance, in many cases, will not impact the algorithm for discovering a standard USB peripheral device and vice versa.

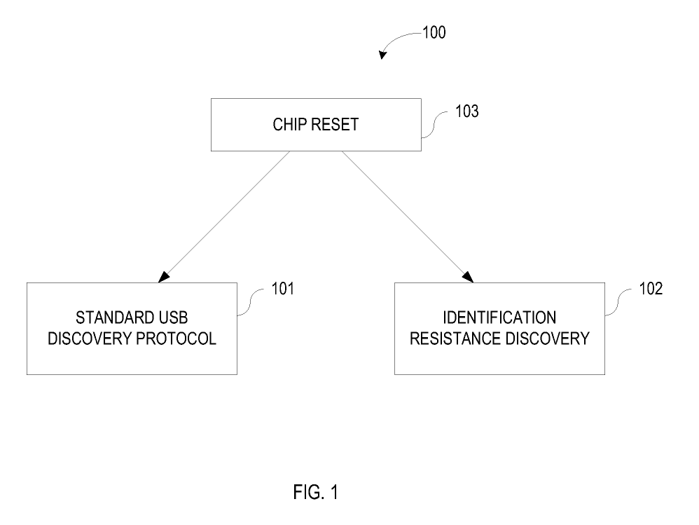

FIG. 1 illustrates generally a flow chart for an example method 100 simultaneously executing two independent state machine modules 101, 102 to discover when a peripheral device is attached to or detached from a port, and, in certain examples, assist in identifying the attached peripheral device. The method 100 can begin with a chip reset 103, such as when power is turned on to a mobile device such as a cell phone. The independent state machine modules 101, 102 can simultaneously begin to execute methods that discover when and what is attached or detached to a port of the mobile device such as a USB port.

In an example, a mobile device can include a processor to coordinate simultaneous and independent execution of the modules 101, 102. In certain examples, the modules 101, 102 are independent from each other such that each module can operate without the other module operating. In some examples, the modules 101, 102 can access a commons memory such that some coordination between the independent modules can be attained. An advantage of the independent modules is the ability to modify one module without affecting the operation of the other module.

In certain examples, the modules 101, 102 can include a standard USB discovery protocol module 101 and a identification resistance discovery module 102. In certain examples, the standard USB discovery protocol module 101 can follow a prescribed protocol to identify the type of attached device. For example, protocols that are part of the USB standard can monitor the voltage bus terminal (VBUS) of a USB port to detect a when a peripheral device attaches to the mobile device or detaches from the mobile device. The validity status of the voltage at the VBUS terminal can be provided as an indicator to other processes of the mobile device. After detecting a peripheral device is attached to the mobile device, the standard USB discovery protocol module 101, comprising hardware, software, or a combination of hardware and software, can be configured to follow a USB protocol, such as the Attach Detection Protocol of the USB standard, to identify whether the attached peripheral device includes an accessory charger adapter (ACA), an ACA dock, a charging downstream port (CDP), a dedicated charging port (DCP), a standard downstream port (SDP), or one or more other standard USB ports. In some examples, after detecting an attached peripheral device, the standard USB discovery protocol module 101 can monitor one or more data lines to detect data communications between the attached peripheral device and the mobile device. In certain examples, after detecting an attached peripheral device, the standard USB discovery protocol module 101 can receive identification information from another process of the mobile device or the identification resistance discovery module 102 to assist in identifying the type of port of the peripheral device the mobile device is attached unto.

In certain examples, the identification resistance discovery module 102 can monitor an identification (ID) pin of a port of the mobile device to detect when a peripheral device is attached to, or detached from, the port of the mobile device. In some examples, the identification resistance discovery module 102 can receive information from the standard USB discovery protocol module 101 to assist in detecting when a peripheral device detaches from the port of the mobile device. For example, for a USB port of the mobile device, the identification resistance discovery module 102 can receive an indication of whether the VBUS voltage is valid from the standard USB discovery protocol module 101. A valid VBUS voltage can indicate that a peripheral device is attached to a USB port of the mobile device. In an example, a valid VBUS voltage can include a voltage greater than a threshold. In some examples, the threshold can be about 4.4 volts.

In certain examples, the identification resistance discovery module 102 can detect that a peripheral device is not attached to, or has detached from, the port of the mobile device when a voltage at the ID pin is floating. In certain examples, the identification resistance discovery module 102 can detect during an idle state, for example, that a peripheral device is attached to the port of the mobile device when a voltage at the ID pin is not floating. Upon detecting that peripheral device is connected to the port, the identification resistance discovery module 102 can receive identification information from an analog-to-digital converter (ADC). In an example, the identification information can include an indication of a resistance value coupled to the ID pin. In an example, the identification resistance discovery module 101 can request that the ADC read and provide the indication of the resistance value a predetermined number of times to debounce the indication of the resistor value. Upon debouncing the indication of the resistor value, the identification resistance discovery module 102 can provide a flag indicating that the type of attached peripheral device has changed. In certain examples, the indication of the resistor value can indicate that the ID pin is shorted, or coupled via a low impedance, to ground. If the ID pin is shorted, the identification resistance discovery module 102 can enable a current limit resistor on the circuitry coupled to the ID pin to save energy. Upon debouncing the indication of the resistance value, the identification resistance discovery module 102 can continue to monitor the ID pin for a change in the indication of the resistance value. In certain examples, if the voltage at the ID pin begins to float, or the voltage at the VBUS pin is invalid, the identification resistance discovery module 102 can proceed to the idle state to detect the next occurrence when the ID pin is not floating. In some examples, the identification resistance discovery module 102 can delay for an interval of time before proceeding to the idle state. The delay can prevent or reduce false triggering of a non-floating ID pin as a peripheral device is detached from the mobile device.

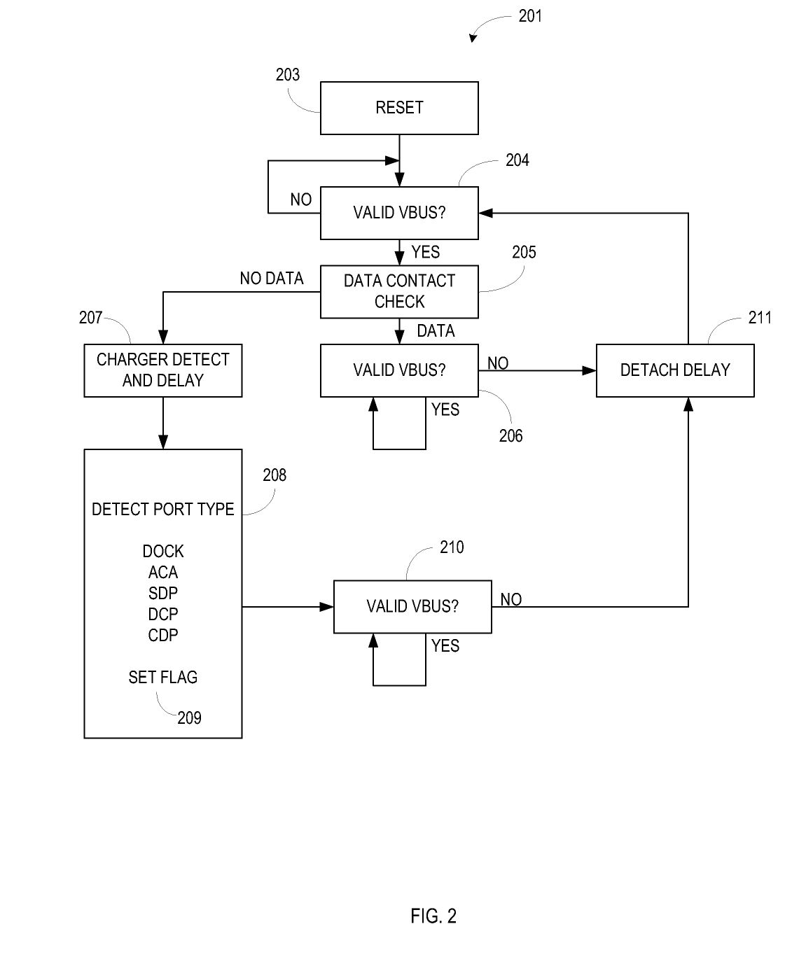

FIG. 2 illustrates generally a flowchart of an example a Universal Serial Bus (USB) discovery method 201. At 203, the USB discovery method 201 can start when a chip of a mobile device is reset such as when the mobile device is turned on or powered up. At 204, the USB discovery method 201 can remain in a loop until a peripheral device is attached to the port of the mobile device and a voltage at the VBUS pin becomes valid. When the voltage at the VBUS pin is valid, the the USB discovery method 201, at 205, can receive an indication of the state of an ID pin of the port. If the indication indicates that the port does not include an ID pin, a voltage of the ID PIN is floating, or the voltage at the ID pin is not floating and the peripheral port is an ACA port, the USB discovery method 201 can branch to continue, at 207, to discover the specific type of standard USB port that is attached to the mobile device. If the indicator indicates the ID pin is not floating and the peripheral port is not an ACA port, than the USB discovery method 201 can branch, at 206, to ignore further identifying the type of port of the peripheral device. At 206, the USB discovery method 201 can remain in a loop until the peripheral is detached such as by detecting an invalid VBUS voltage.

In certain examples, a protocol for the mobile device port can use one or more measurements to detect the presence, or lack thereof, of a charger attached to the port of the mobile device. In certain examples, at 207, a charger parameter can be adjusted to indicate whether a charger is attached to the port of the mobile device. In certain examples, such as for a USB port, a USB standard exists for detecting whether a charger is attached to the USB. In an example, detecting whether a charger is attached to a USB port of the mobile device can include receiving a parameter indicative of a resistance value attached to the ID pin of the USB port. In an example, if the resistance value is about 122 kiloohms (kohms) to about 126 kohms and the charger parameter does not indicate that a charger is attached, the port of the attached peripheral device can be identified as an ACA type port. In an example, if the resistance value is about 122 kohms to about 126 kohms and the charger parameter does indicate that a charger is attached, the port of the attached peripheral device can be identified as a dock type port.

At 208, an ACA port, a dock port, and additional port types of the attached peripheral device can be identified and one or more flags can be adjusted 209 to make the identification of the attached peripheral port available to other processes of the mobile device. At 210, after identifying the attached port of the peripheral device, the validity of the voltage at the VBUS pin can be determined. In certain examples, at 211, upon detection that a peripheral device has been detached, such as by detecting an invalid voltage at the VBUS pin, a delay can be executed before again evaluating the validity of the voltage at the VBUS pin at 204. In certain examples, the detach delay can prevent or reduce false triggering of a valid voltage at the VBUS pin as a peripheral device is detached from the mobile device.

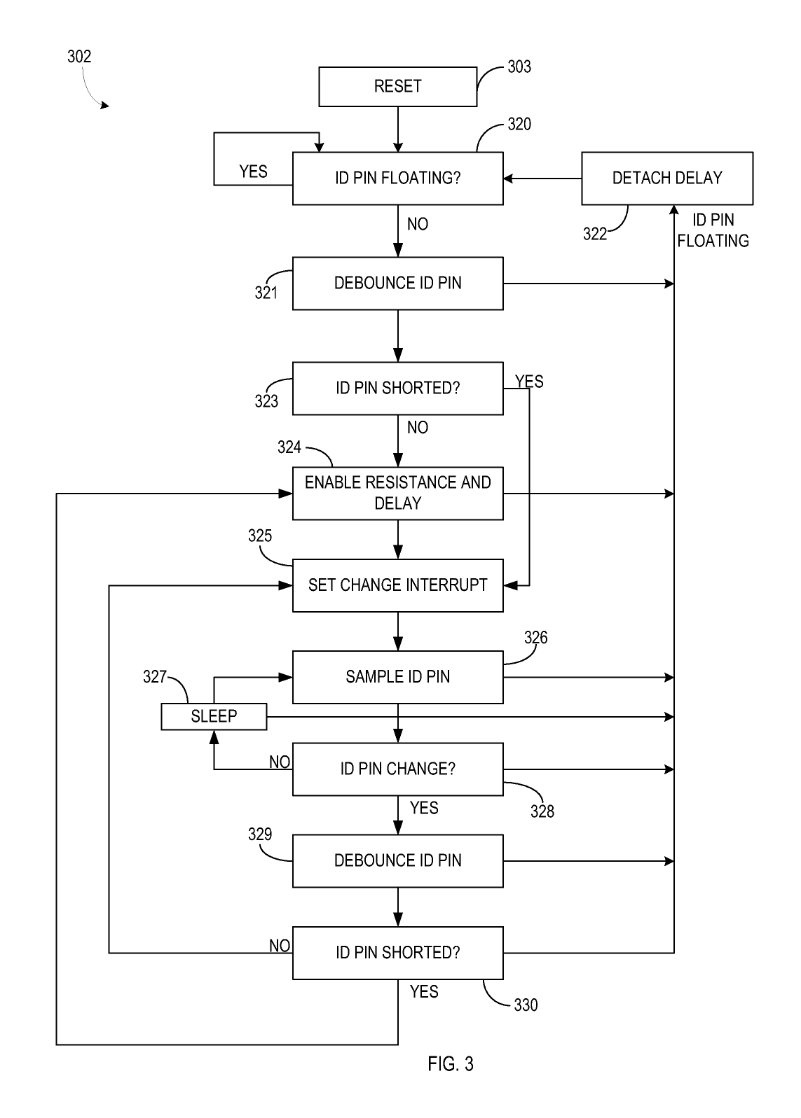

FIG. 3 illustrates generally a flowchart of an example of an identification (ID) resistance discovery method 302. In certain examples, at 303, the ID resistance discovery method 302 can start when a chip of a mobile device is reset such as when the mobile device is turned on or powered up. In an example, at 320, the voltage at an ID pin of a port of the mobile device can be evaluated or monitored. If the ID pin is floating, the ID resistance discovery method 302 can remains in a loop at 301 evaluating and monitoring the voltage at the ID pin. At 321, if the voltage of the ID pin is not floating, the voltage at the ID pin can be debounced. In an example, debouncing the voltage at the ID pin can include sampling the information associated with the ID pin. In certain examples, debouncing the voltage at the ID pin can include requiring that a predetermined number of successive samples of the information associated with the ID pin match each other, or match each other within a match threshold. If the voltage at the ID pin begins to float during the debouncing at 321, a detach delay at 322 can be executed and, at 320, the ID pin can again be evaluated and monitored. In certain examples, the ID resistance discovery method 302 can enable and disable an analog-to-digital converter (ADC) to sample the information associated with the ID pin, and to save energy compared to keeping the ADC active at times when the ADC function is not needed.

If the information associated with the ID pin successfully debounces, at 323, the information associated with the ID pin can be evaluated to determine if the ID pin is shorted or is attached to a low impedance pin of a peripheral device port. At 324, if the ID pin is shorted, or or is attached to a low impedance pin of a peripheral device port, a resistance can be enabled to minimize the current of the ID pin and to reduce the overall energy usage of the mobile device. In an example, at 324, the ID resistance discovery method 302 can delay after enabling the current limiting resistance. At 325, a flag or interrupt can be adjusted to indicate to other processes of the mobile device that a peripheral device has been attached to the mobile device. In an example, the flag or interrupt can be provided as an indicator to other processes of the mobile device. In certain examples, the flag or interrupt can be used by the other processes of the mobile device to identify the specific functionality offered by the peripheral device. In certain examples, the other processes of the mobile device can conform the operation of the mobile device to make use of and, in some examples, control those identified functions. In certain examples, a peripheral device can be identified by the resistance coupled to the ID pin of a USB port of the mobile device. In some examples, an indication of the resistance coupled to the ID pin can be made available to the processes of the mobile device, such as the USB discovery method 201 discussed previously.

After initially identifying that a peripheral device is coupled to the port of the mobile device, at 326, the ID resistance discovery method 302 can further sample the information associated with the ID pin. The newly sampled information can be evaluated, at 328, to determine if the resistance coupled to the ID pin has changed. If the resistance value has not changed, the ID resistance discovery method 302, at 327, can sleep for a predetermined interval and then again sample the information associated with the ID pin at 326. If the resistance value has changed, the ID resistance discovery method 302 can debounce the information associated with the ID pin at 329. The ID resistance discovery method 302 can then evaluate whether the ID pin is shorted, at 330, and can proceed to enabling a resistance of the ID pin, at 324, if the ID pin is shorted, or set a flag or interrupt at 325 if the ID pin is not shorted. In certain examples, the ID resistance discovery method 302 can flow from one or more actions, including but not limited to 321, and 323-330, to a detach delay at 322 if the voltage at the ID pin is floating. In certain examples, the detach delay 322 can prevent or reduce false triggering of a non-floating ID pin as a peripheral device is detached from the mobile device. Upon completion of the detach delay 322, the ID resistance discovery method 302 can again evaluate or monitored the voltage at the ID pin of a port of the mobile device at 320.

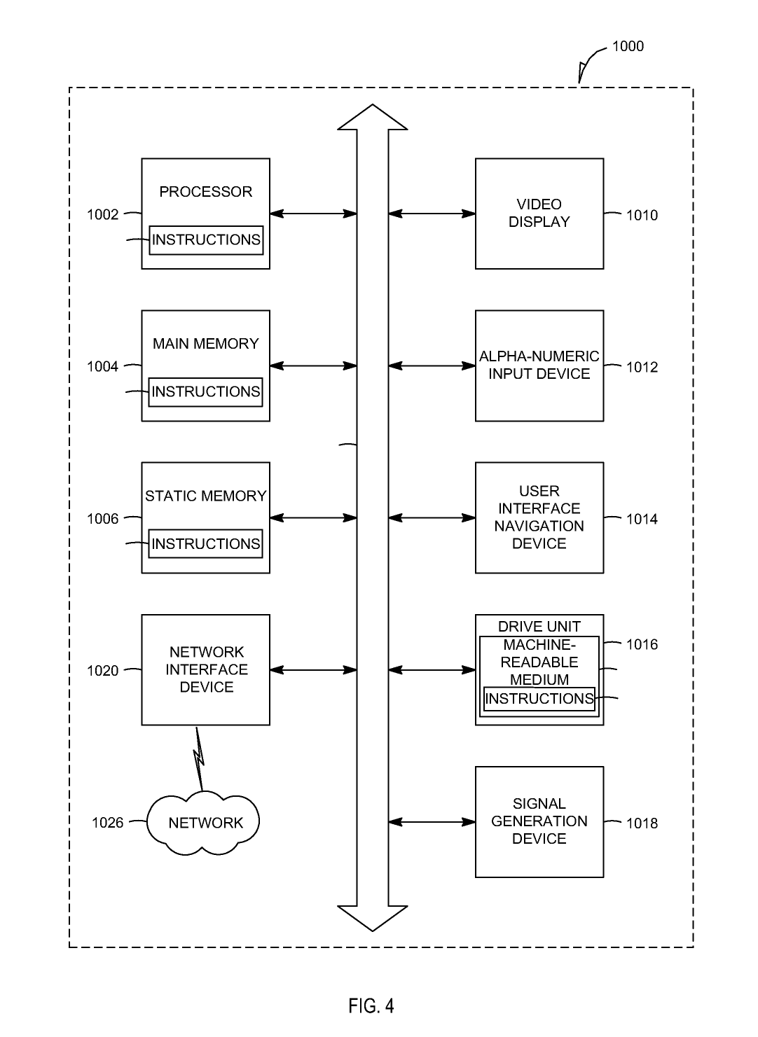

FIG. 4 is a block diagram of machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Additional Notes

In Example 1, a method can include monitoring a supply bus pin of a USB port for a valid voltage using a first state machine, monitoring an ID pin of the USB port for a non-floating voltage using a second state machine, simultaneously and independently executing the first state machine and the second state machine, wherein the first state machine is different than the second state machine, providing a first indicator configured to provide a first indication that a first peripheral device is coupled to the USB port when the valid voltage is detected at the supply bus pin using the first state machine, and to provide a second indication that the USB is unattached when an invalid voltage is detected at the supply bus pin using the first state machine, and providing a second indicator using the second state machine, the second indicator configured to provide a third indication that an attached state of the USB port has changed based on a non-floating voltage detected at the ID pin.

In Example 2, the monitoring a supply bus pin for a valid voltage of Example 1 optionally includes monitoring a supply bus pin for a voltage greater than a first threshold.

In Example 3, the monitoring the ID pin of any one or more of Examples 1-2 optionally includes detecting that an ID voltage at the ID pin is not floating.

In Example 4, the monitoring the ID pin of any one or more of Examples 1-3 optionally includes deboucing the ID voltage at the ID pin using an analog-to-digital converter (ADC).

In Example 5, the monitoring the ID pin of any one or more of Examples 1-4 optionally includes enabling the analog-to-digital converter enabling the ADC using the second state machine to execute the debouncing.

In Example 6, the monitoring the ID pin of any one or more of Examples 1-5 optionally includes disabling the ADC at a conclusion of the debouncing to save energy.

In Example 7, the monitoring the ID pin of any one or more of Examples 1-6 optionally includes storing an indication of the connected peripheral device using the ID voltage.

In Example 8, monitoring the ID pin of any one or more of Examples 1-7 optionally includes adjusting a first flag, using the second state machine, to indicate that a peripheral device is attached to the USB port.

In Example 9, the method of any one or more of Examples 1-8 optionally includes sampling information about the voltage at the ID pin, using the second state machine, after providing an indication that a peripheral device is attached to the USB port.

In Example 10, the method of any one or more of Examples 1-9 optionally includes comparing the sampled information to the stored indication of the connected peripheral device and setting a mismatch flag if the sampled information does not substantially match the stored indication of the connected peripheral device.

In Example 11, the method of any one or more of Examples 1-8 optionally includes resetting a mismatch flag if the sampled information substantially matches the stored indication of the connected peripheral device, and re-sampling the information about the voltage at the ID pin after a predetermined delay.

In Example 12, the method any one or more of Examples 1-8 optionally includes deboucing the voltage at the ID pin in response to the set mismatch flag, and adjusting the first flag to indicate that the connected peripheral device has changed.

In Example 13, the monitoring the ID pin any one or more of Examples 1-12 optionally includes providing an indication that the connected peripheral device is not connected to the USB port if the voltage at the ID pin is floating

In Example 14, the monitoring the ID pin any one or more of Examples 1-13 optionally includes receiving at the second state machine an indication that the ID pin is shorted to ground. In Example 15, the monitoring the ID pin any one or more of Examples 1-14 optionally includes receiving at the second state machine an indication that the ID pin is not shorted to ground.

In Example 16, the first peripheral device and the second peripheral device any one or more of Examples 1-8 optionally are the same device. In Example 17, a mobile device can include a Universal Serial Bus (USB) port configured to couple to standard USB peripheral devices and non-standard USB peripheral peripheral devices, a first state machine configured to identify standard USB peripherals coupled to the USB port, a second state machine configured to identify non-standard USB peripherals coupled to the USB port, wherein the second state machine is independent of the first state machine, and a processor configured to coordinate simultaneous and independent execution of the first and second state machines.

In Example 18, the first state machine of any one or mpre of Examples 1-17 optionally is configured to identify a type of USB port of a connected standard peripheral device.

In Example 19, the second state machine any one or more of Examples 1-18 optionally is configured to monitor a voltage at an ID pin of the USB port to detect an attached state of the USB port.

In Example 20, the second state machine any one or more of Examples 1-19 optionally is configured to enable an analog-to-digital converter (ADC) to receive information associated with the voltage at the ID pin and to disable the ADC to save energy.

In Example 21, a method for identifying whether a peripheral device is attached to a USB port of a mobile electronic device and, if attached, identifying the type of peripheral device can include simultaneously monitoring a first voltage of a first pin of the USB port using a first state machine and monitoring a second voltage of a second pin of the USB port using a second state machine.

In Example 22, the monitoring the second voltage of any one or more of Examples 1-21 optionally includes maintaining the second state machine in an idle state until the second voltage is not floating.

In Example 23, the monitoring the second voltage of any one or more of Examples 1-22 optionally includes enabling an analog-to-digital converter (ADC) to provide a first value indicative of an identification resistance coupled to the second pin, enabling the ADC to provide a second value indicative of the identification resistance coupled to the second pin, and incrementing a match count parameter if the first value substantially matches the second value. In Example 24, if one of the first and second values indicates an identification resistance is below a minimum threshold, the method of any one or more of Examples 1-23 optionally includes enabling a detection resistance to limit current of the second pin, and enabling a delay interval.

In Example 25, at conclusion of the delay interval, the method of any one or more of Examples 1-24 optionally includes setting an interrupt using the second state machine, the interrupt indicative of a change in the type of peripheral device coupled to the USB port.

In Example 26, the method of any one or more of Examples 1-25 optionally includes monitoring the voltage at the second pin to detect a change in the identification resistance.

In Example 27, the monitoring the voltage at the second pin to detect a change in the identification resistance of any one or more of Examples 1-26 optionally includes enabling the ADC to sample the voltage at the second pin, and disabling the ADC during intervals between sampling the voltage at the second pin to save energy.

In Example 28, the monitoring the voltage at the second pin to detect a change in the identification resistance of any one or more of examples 1-27 optionally includes detecting a change in the identification resistance, debouncing the change in the identification resistance, and setting the interrupt using the second state machine. The interrupt can be indicative of a change in the type of peripheral device coupled to the USB port.

In Example 29, the monitoring the voltage at the second pin to detect a change in the identification resistance of any one or more of Examples 1-28 optionally includes detecting the voltage at the second pin is floating, and providing an indication using the second state machine that the USB port is not attached to a peripheral device.

Example 30 can include, or can optionally be combined with any portion or combination of any portions of any one or more of Examples 1-29 to include, subject matter that can include means for performing any one or more of the functions of Examples 1-29, or a machine-readable medium including instructions that, when performed by a machine, cause the machine to perform any one or more of the functions of Examples 1-29.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry(e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

The disk drive unit 1016 includes a machine-readable medium 1022 on which is stored one or more sets of instructions and data structures (e.g., software) 1024 embodying or used by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media. In some examples, the instructions 1024 may also reside within static memory 1006.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

The above description is intended to be illustrative, and not restrictive. In some examples, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A method comprising:
monitoring a supply bus pin of a USB port for a valid voltage using a first state machine;
monitoring an ID pin of the USB port for a non-floating voltage using a second state machine;
simultaneously and independently executing the first state machine and the second state machine, wherein the first state machine is different than the second state machine;
providing a first indicator using the first state machine, the first indicator configured to provide (1) a first indication that a first peripheral device is coupled to the USB port when the valid voltage is detected at the supply bus pin, and (2) a second indication that the USB is unattached when an invalid voltage is detected at the supply bus pin; and
providing a second indicator using the second state machine, the second indicator configured to provide a third indication that an attached state of the USB port has changed based on a non-floating voltage detected at the ID pin.

2. The method of claim 1, wherein monitoring a supply bus pin for a valid voltage includes monitoring a supply bus pin for a voltage greater than a first threshold.

3. The method of claim 1, wherein the monitoring the ID pin includes detecting that an ID voltage at the ID pin is not floating.

4. The method of claim 3, wherein the monitoring the ID pin includes deboucing the ID voltage at the ID pin using an analog-to-digital converter (ADC).

5. The method of claim 4, wherein the monitoring the ID pin includes enabling the analog-to-digital converter enabling the ADC using the second state machine to execute the debouncing.

6. The method of claim 4, wherein the monitoring the ID pin includes disabling the ADC at a conclusion of the debouncing to save energy.

7. The method of claim 4, wherein the monitoring the ID pin includes storing an indication of the connected peripheral device using the ID voltage.

8. The method of claim 4, wherein the monitoring the ID pin includes adjusting a first flag, using the second state machine, to indicate that a peripheral device is attached to the USB port.

9. The method of claim 8, including sampling information about the voltage at the ID pin, using the second state machine, after providing an indication that a peripheral device is attached to the USB port.

10. The method of claim 9, including comparing the sampled information to the stored indication of the connected peripheral device and setting a mismatch flag if the sampled information does not substantially match the stored indication of the connected peripheral device.

11. The method of claim 10, including resetting a mismatch flag if the sampled information substantially matches the stored indication of the connected peripheral device, and re-sampling the information about the voltage at the ID pin after a predetermined delay.

12. The method of claim 10, including deboucing the voltage at the ID pin in response to the set mismatch flag; and
adjusting the first flag to indicate that the connected peripheral device has changed.

13. The method of claim 4, wherein the monitoring the ID pin includes providing an indication that the connected peripheral device is not connected to the USB port if the voltage at the ID pin is floating

14. The method of claim 4, wherein the monitoring the ID pin includes receiving at the second state machine an indication that the ID pin is shorted to ground.

15. The method of claim 4, wherein the monitoring the ID pin includes receiving at the second state machine an indication that the ID pin is not shorted to ground.

16. The method of claim 1, wherein the first peripheral device and the second peripheral device are the same device.

17. A mobile device comprising:
a Universal Serial Bus (USB) port configured to couple to standard USB peripheral devices and non-standard USB peripheral peripheral devices;
a first state machine configured to identify standard USB peripherals coupled to the USB port;
a second state machine configured to identify non-standard USB peripherals coupled to the USB port, wherein the second state machine is independent of the first state machine; and
a processor configured to coordinate simultaneous and independent execution of the first and second state machines.

18. The mobile device of claim 17, wherein the first state machine is configured to identify a type of USB port of a connected standard peripheral device.

19. The mobile device of claim 17, wherein the second state machine is configured to monitor a voltage at an ID pin of the USB port to detect an attached state of the USB port.

20. The mobile device of claim 19, wherein the second state machine is configured to enable an analog-to-digital converter (ADC) to receive information associated with the voltage at the ID pin and to disable the ADC to save energy.
